(19) United States
(12) Patent Application Publication
(10) Pub. No.: US 2025/0297464 A1
(43) Pub. Date: Sep. 25, 2025

(54) SYSTEMS AND METHODS FOR PREDICTING A CONDITION OF A MACHINE

(71) Applicant: Caterpillar Inc., Peoria, IL (US)

(72) Inventors: Arick M. BAKKEN, Raleigh, NC (US); Christopher A. JUNCK, Hyogo (JP); Takeshi TSUNEYOSHI, Hyogo-ken (JP)

(73) Assignee: Caterpillar Inc., Peoria, IL (US)

(21) Appl. No.: 18/615,288

(22) Filed: Mar. 25, 2024

(51) Int. Cl. E02F 9/26; G07C 5/08

(52) U.S. Cl. CPC E02F 9/267; G07C 5/0808

(57) ABSTRACT

Systems and methods for predicting the conditions of one or more components of a machine are disclosed. The method includes receiving impact data from one or more sensors associated with the machine. The method includes processing the impact data to assign damage values to one or more components of the machine. The method includes generating one or more recommendations or machine life estimations based on the damage values in a user interface of the machine.

### TECHNICAL FIELD

The present disclosure relates generally to the field of monitoring and diagnosis, and more particularly, to a monitoring system that combines a plurality of sensors and algorithm modalities for monitoring the structural health of an industrial machine.

### BACKGROUND

Integration of real-time sensor data into accurate remaining useful life (RUL) calculations of a mobile industrial machine requires addressing issues related to data quality, data reliability, and synchronization across various machine components. For example, data accuracy and precision pose significant challenges due to sensor limitations and calibration intricacies. The delay in the duration of sampling time while determining RUL is often influenced by the need to accumulate sufficient operational data to capture diverse and representative machine usage patterns. The complexity of machine systems demands sophisticated modeling techniques that accurately capture degradation processes and failure modes. The diverse operational conditions and usage patterns of such machines, for example, excavators, make it challenging to create a universally applicable predictive model for determining their RUL. It is also technically challenging to ensure synchronization between real-world data and simulated environments, thereby affecting the reliability of correlation and the subsequent accuracy of damage prediction.

U.S. Patent Application Publication No. US2016222946A1, published on Aug. 4, 2016 (“the '946 publication”), describes a system for monitoring the movements of the structures of a machine to generate values for prompting necessary measures for maintenance or corrective actions. The '946 publication, however, does not consider the swing impact or the drop impact to the machines while calculating the values for detecting possible damage.

The system of the present disclosure may solve one or more of the problems set forth above and/or other problems in the art. The scope of the current disclosure, however, is defined by the attached claims, and not by the ability to solve any specific problem.

### SUMMARY

In one aspect, a computer-implemented method for predicting conditions of one or more components of a machine is disclosed. The computer-implemented method includes: receiving impact data from one or more sensors associated with the machine; processing the impact data to assign damage values to the one or more components of the machine; and generating one or more recommendations or machine life estimations based on the damage values in a user interface of the machine.

In another aspect, a system for predicting remaining useful life of one or more components of a machine is disclosed. The system includes: one or more processors, and at least one non-transitory computer readable medium storing instructions which, when executed by the one or more processors, cause the one or more processors to perform operations including: receiving sensor data from one or more sensors associated with the machine; processing the sensor data to determine an impact on the one or more components of the machine; assigning damage values to the one or more components of the machine based on the determined impact; and generating one or more notifications for performing one or more mitigation actions based on the damage values in a user interface of the machine.

In yet another aspect, a non-transitory computer readable medium for predicting conditions of one or more components of a machine is disclosed. The non-transitory computer readable medium storing instructions which, when executed by one or more processors, cause the one or more processors to perform operations including: receiving swing impact data or drop impact data from one or more sensors associated with the machine; processing the swing impact data or the drop impact data to assign a damage values to the one or more components of the machine; and generating one or more notifications or machine life estimations based on the damage values in a user interface of the machine.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of an exemplary machine, according to aspects of the disclosure.

FIG. 2A is a diagram that illustrates the swing motion of the machine of FIG. 1.

FIG. 2B is a diagram that illustrates the drop motion of the machine of FIG. 1.

FIG. 3A is a schematic illustration of a system for determining a condition of one or more components of the machine of FIG. 1.

FIG. 3B is a diagram that illustrates a graph for determining a condition of one or more components of the machine of FIG. 1.

FIG. 4 is an exemplary output of the system of FIG. 3A.

FIG. 5 is a flowchart of a process implemented by the system of FIG. 3A.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

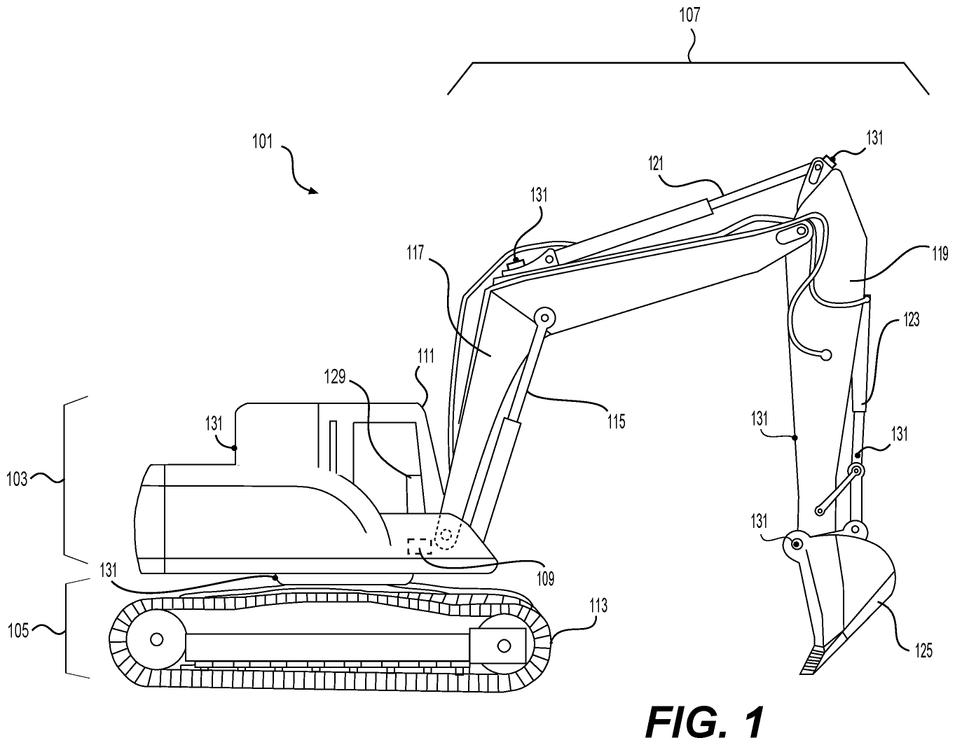

FIG. 1 is a schematic diagram of an exemplary machine 101. Although FIG. 1 illustrates machine 101 as being an excavator, machine 101 may include any type of industrial machine. For example, machine 101 may be a digging machine (e.g., a backhoe, dozer, trencher, dragline, or any other similar machine) or a loading machine (e.g., wheeled or tracked loader, an excavator, a cable shovel, a stack reclaimer, or any other similar machine). Machine 101 includes a main body 103, an undercarriage 105, and an arm assembly 107. The main body 103 includes an engine (not illustrated in FIG. 1), controller 109, and a cabin 111, and provides stability and support to machine 101. The undercarriage 105 includes track (or wheels) 113 which facilitates the mobility of machine 101 across various terrains. The arm assembly 107 includes a first hydraulic actuator 115, a boom 117, a stick 119, a second hydraulic actuator 121, a third hydraulic actuator 123, and an implement 125 (illustrated as a bucket, but may include any other work implements) for performing digging, lifting, or loading operations. Boom 117 may be fixedly connected to main body 103. Boom 117 may be fixedly connected at another end to stick 119, and stick 119 may be fixedly connected at another end to implement 125. The first hydraulic actuator 115 may be connected to boom 117 to actuate boom 117; the second hydraulic actuator 121 may be connected to boom 117 and stick 119 to actuate stick 119; and the third hydraulic actuator 123 may be connected to stick 119 and implement 125 to actuate implement 125. FIG. 1 shows sensors 131 positioned at specific locations of machine 101 (e.g., cabin 111, stick 119, second hydraulic actuator 121, third hydraulic actuator 123, implement 125, or swing area), however, it should be understood that sensors 131 may be positioned anywhere on machine 101 to enable comprehensive data collection and real-time monitoring of various operational and conditional parameters.

Machine 101 may be autonomous, semi-autonomous, manual, or may be controlled remotely, allowing for optimized performance in diverse work environments. The cabin 111 of machine 101 is configured to enclose an operator therein, and may include a user interface 129 displaying various controls for controlling the operation of, for example, the engine, boom 117, stick 119, and implement 125. The user interface 129 may display a myriad of information, including machine status, performance metrics, and operational data, providing operators with a comprehensive overview for efficient control and decision-making. In one example, the operator may swing the main body 103 of machine 101 horizontally (e.g., swing motion) to accurately position machine 101 for facilitating various tasks (e.g., digging, lifting, placement of materials, etc.). In one example, the operator may articulate boom 117 and stick 119 to position implement 125 (e.g., tilt, rotate, and scoop or curl) to perform a downward movement for various tasks (e.g., digging, trenching, material handling, etc.).

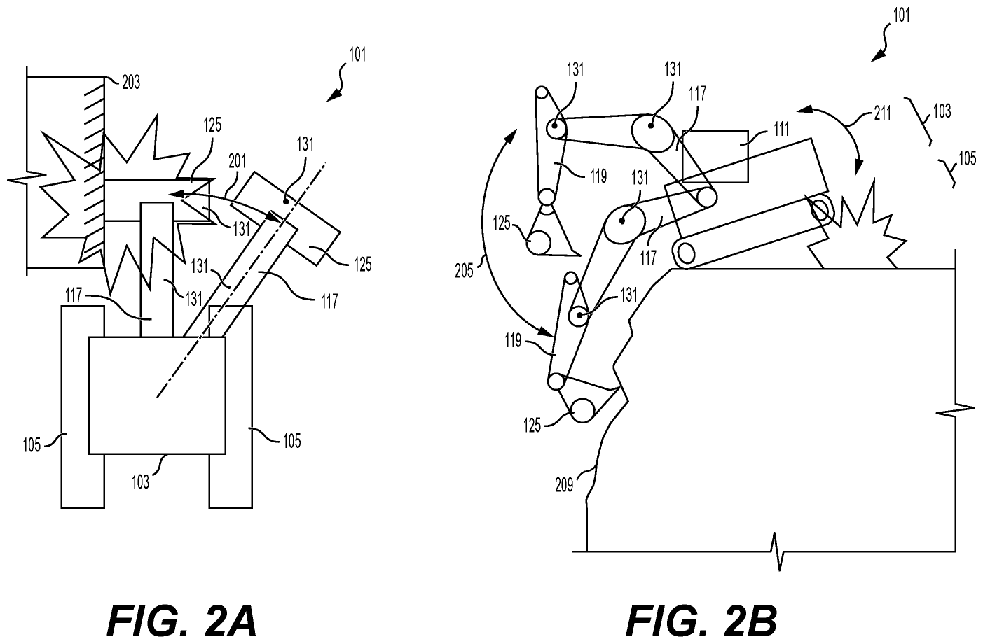

FIG. 2A illustrates the swing motion of machine 101. In one instance, main body 103 of machine 101 may rotate horizontally (e.g., movement 201) on its undercarriage 105, allowing the operator to rotationally position boom 117, stick 119, and implement 125 in different directions without repositioning the entire machine 101. Such swing motion of machine 101 may be detected and monitored using various sensors 131 placed on various parts of machine 101. In one example, sensors 131 may include load sensors positioned on the hydraulic actuator(s), boom 117, or stick 119 to assess the weight and balance of the load during the swing. Additionally or alternatively, sensors 131 may include inertial measurement unit (IMU) sensors positioned anywhere on the main body 103 or swing area of machine 101 for detecting changes in orientation and rotation speed. An impact from the swing motion (swing impact) as shown schematically in FIG. 2A may be significant during certain operations, such as when machine 101 is swinging a loaded implement 125. In one example, the weight of the materials in implement 125 may amplify the damage when machine 101 collides with structure 203 (e.g., a wall or any objects). Sensors 131 may detect and provide real-time data on the swing impact, ultimately enabling the system to analyze the severity of the impact. For example, load sensors may gauge fluctuations in the weight distribution within implement 125, and IMU sensors may measure sudden changes in acceleration or vibration during the swinging motion. As implement 125 swings and hits structure 203, the additional weight of the materials in implement 125 may intensify the force exerted on both implement 125 and structure 203. This heightened impact may strain the structural integrity of implement 125, leading to deformation, stress, or even fractures.

Swing impacts may also place stress on the hydraulic components of machine 101 and may increase wear on seals, valves, and other hydraulic system elements. In addition, the swing bearing which allows main body 103 of machine 101 to rotate on the undercarriage 105 may experience increased mechanical stress during swing impacts, and over time, this stress may contribute to wear on the swing bearing. Stresses from swing impacts may also lead to cracks or deformations on other structures of machine 101 (e.g., boom 117, stick 119, implement 125, and other components) that may affect the overall performance and safety of machine 101.

FIG. 2B illustrates the drop motion of machine 101. In one instance, machine 101 may perform a controlled downward movement (e.g., movement 205) of boom 117, stick 119, and implement 125 for performing various tasks (e.g., excavation, material handling, trenching, etc.). Applying excessive force to implement 125 during the lifting operation, may cause the back end of machine 101 (e.g., main body 103 and undercarriage 105) to elevate from the ground. When the back end of machine 101 lifts off the ground, it compromises the machine's stability, increasing the risk of accidents, such as tipping over. A drop motion is observed when the force on implement 125 is removed, causing the back end of machine 101 to suddenly drop on the ground. In one example, during an operation, implement 125 of machine 101 may get caught on a feature of wall 209 of a trench (e.g., tree roots, boulders or rocks, pipes or cables, a protruding ledge, etc.). When implement 125 applies force against the feature of wall 209 to release itself, the back end of machine 101 may lift off the ground (e.g., movement 211). However, once implement 125 is successfully uncoupled from the feature, the back end of machine 101 may fall on the ground (e.g., movement 211). The impact of the fall may induce damage to machine 101. Such drop motion of machine 101 may be detected and monitored using sensors 131 placed on various parts of machine 101. In one example, sensors 131 may include IMU sensors positioned on machine 101 (e.g., main body 103, undercarriage 105, etc.) to measure pitch rate or the tilting movement of the main body 103 and undercarriage 105. The pitch rate is a measure of the rate machine 101 is tilting forward or backward its lateral axes. An excessive pitch movement may lead to an unbalanced state, potentially causing the back end of machine 101 to lift off the ground. For example, if machine 101 is digging too deep or encounters an obstacle, the IMU may register abrupt changes in the pitch rate that may indicate the risk of the back end lifting off the ground or a drop impact. For example, machine 101, while traveling on a worksite, may hit an obstacle (e.g., a rock) due to an operator's error, limited visibility of the obstacle, or the momentum of machine 101. The impact may throw machine 101 off-balance, causing machine 101 to tilt or tip on one side. This imbalance may lead to the lifting of undercarriage 105 off the ground. The subsequent downward motion of machine 101 while returning to the ground may be detected by the IMU sensors, and the sudden jolt experienced during the drop impact may damage or put stress on undercarriage 105 and/or main body 103.

In one example, repeated and forceful drop impacts may cause structural damages (e.g., bending, cracking, deformation, or wear) to undercarriage 105 which comes into direct contact with the ground during the drop, affecting the overall stability and maneuverability of machine 101. In one example, repeated and forceful drop impacts may induce structural stress to the connection between the main body 103 and undercarriage 105 (e.g., swing area), leading to misalignment, wear, or damage.

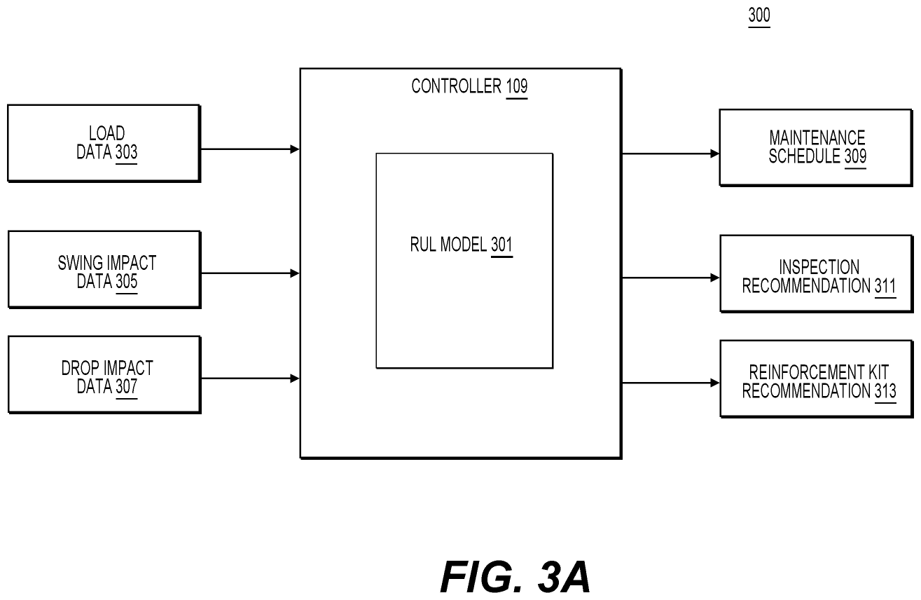

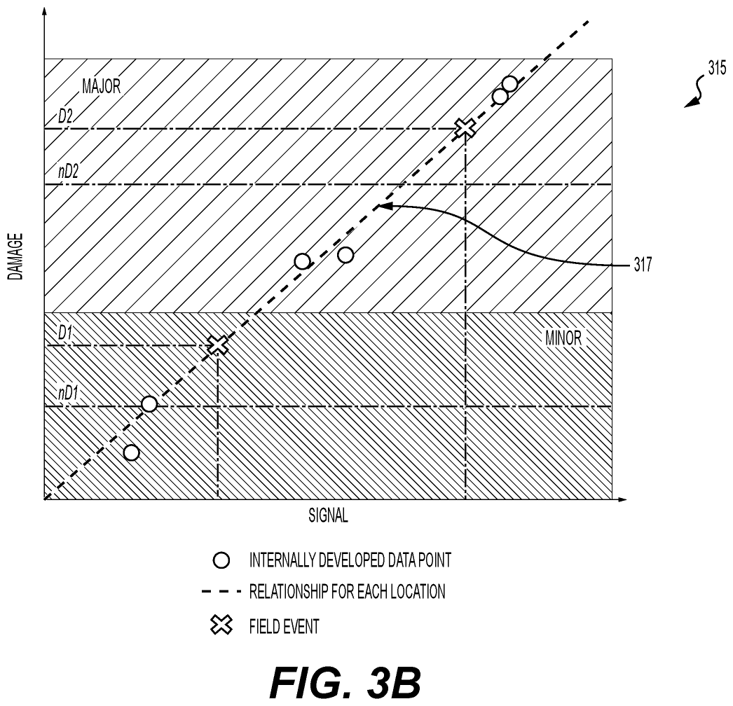

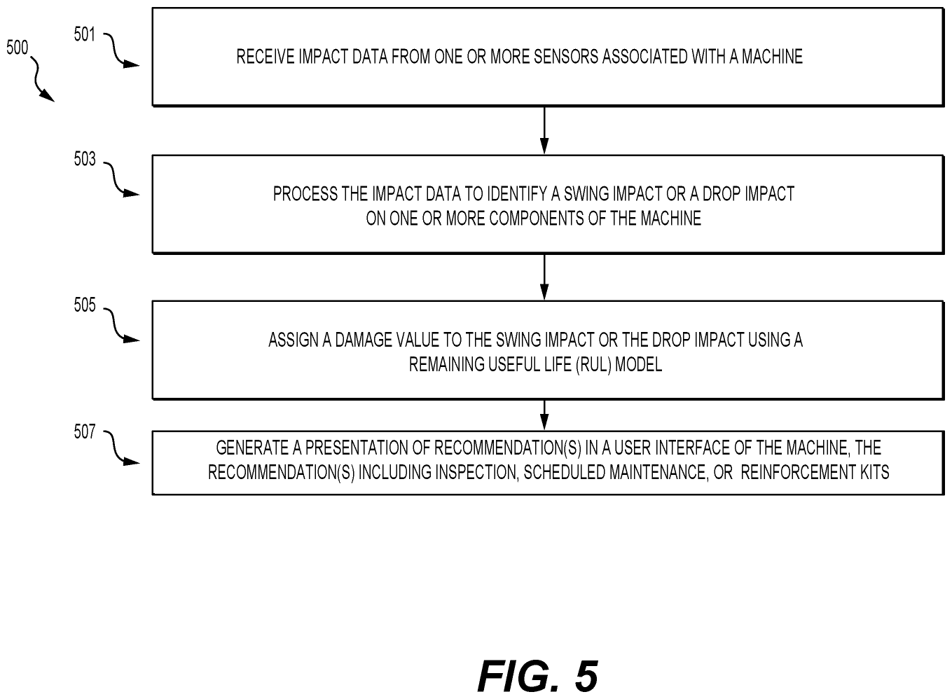

FIG. 3A illustrates system 300 for determining, in real-time or near real-time, the condition of one or more components of machine 101. The system 300 includes a controller 109 for managing and regulating various aspects of the engine's operation. In one instance, controller 109 may be communicably coupled to the sensors 131. The controller 109 may include any appropriate hardware, software, firmware, etc. to carry out the methods described in this disclosure, including the method of FIG. 5. The controller 109 may include one or more processors, memory, a secondary storage device, communication systems, and/or other appropriate hardware. The processors may be, for example, a single or multi-core processor, a digital signal processor, a microcontroller, a general purpose central processing unit (CPU), a field programmable gate array (FPGA), a graphics processing unit (GPU), and/or other conventional processor or processing/controlling circuit or controller. The processors may embody microprocessors, for example, a single microprocessor or multiple microprocessors. The memory or secondary storage device associated with controller 109 may be non-transitory computer-readable media that store data and/or software routines that may assist controller 109 in performing its functions. In these aspects, the memory or secondary storage device may include, for example, read-only memory (ROM), random access memory (RAM), flash or other removable memory, or any other appropriate and conventional memory. Further, the memory or secondary storage device associated with controller 109 may also store data received from the various sensors 131.

In one instance, controller 109 may rely on input from various sensors (e.g., sensors 131) placed throughout machine 101 for precise, controlled, and safe operation of machine 101 during swing movements and load-handling activities. In one instance, controller 109 with RUL model 301 may optimize maintenance strategies and extend the overall lifespan of machine 101. RUL model 301 may receive load data 303, swing impact data 305, and drop impact data 307 from sensors 131. In one example, the load data 303 from sensors 131 (e.g., load sensor) may indicate the weight of the load handled by machine 101 during load-handling activities. In one example, swing impact data 305 from sensors 131 may indicate damage to one or more components of machine 101 upon collision with structure 203 (as illustrated in FIG. 2A). In one example, drop impact data 307 from sensors 131 may indicate damage to one or more components of machine 101 when the back end of machine 101 falls on the ground once implement 125 is uncoupled from feature of wall 209 of a trench (as illustrated in FIG. 2B). It should be understood that RUL estimation may encompass a spectrum of damaging events beyond the swing impact and the drop impact. By recognizing the multifaceted nature of damaging events, RUL model 301 may provide a comprehensive framework for evaluating the ongoing viability and effectiveness of one or more components of machine 101 throughout its lifecycle. By adopting a comprehensive approach, RUL model 301 may account for various types of wear, degradation, and failure mechanisms that equipment may encounter throughout its operational lifespan.

RUL model 301 may utilize the received sensor data and internally developed relationships to estimate the damage during each field event. In one instance, internally developed relationships may indicate the relationship between force and damages learned by RUL model 301 during a training process. For example, RUL model 301 may utilize machine learning algorithms or a simulation-based approach to correlate the measured forces and damages experienced to determine internally developed relationships. RUL model 301 may employ rigorous testing methodologies, such as a swing impact test or a drop impact test to determine a relationship between forces observed and damages experienced by the test machine. In one example, the swing impact test includes swinging one or more components of a test machine (e.g., implement of the test machine) against a solid structure (e.g., wall) to measure the force and damage experienced by one or more components of the test machine. In one example, the drop impact test includes assessing the impact of a drop on one or more components of the test machine (e.g., undercarriage of the test machine) to measure the force exerted during the drop and the resulting damages.

In one instance, RUL model 301 may generate a graph (e.g., graph 315 of FIG. 3B) for one or more components of machine 101 (e.g., a graph focused on boom 117 or any other area of interest of machine 101). RUL model 301 may divide graph 315 into major and minor sections to indicate the severity of potential damages. The major section of graph 315 may include data points associated with higher damage potential on machine 101, while the minor section of graph 315 may include data points associated with lower impact on machine 101. The internally developed relationships of measured forces to one or more components of the test machine during the swing impact test or the drop impact test may be represented as diagonal line 317 that relates the actual sensed forces to damage values.

RUL model 301 may generate nominal values based on internally developed relationships and plot these values in graph 315. In one instance, the nominal values may be predefined benchmarks representing the expected conditions during various types of events (e.g., swing impact, drop impact) for machine 101. In this example, the nominal values may include minor a nominal value (nD1) plotted in the minor section of graph 315 and a major nominal value (nD2) plotted in the major section of graph 315. The minor nominal value (nD1) may indicate parameters that are considered less critical or have a lower impact on machine 101, and a slight deviation from this value may not result in a significant impact on machine 101. The major nominal value (nD2) may indicate parameters that are critical or have a significant impact on machine 101, and deviations from this value may have a substantial impact on the performance, safety, or longevity of machine 101. A recognized drop impact may nominally correspond to a damage value, and a recognized swing impact may nominally correspond to a different damage value.

RUL model 301 may generate actual values (D1 and D2) based on real-time sensed forces during an in-field swing impact or drop impact on one or more components of machine 101. The actual values (D1 and D2) are charted on graph 315, and coincide with diagonal line 317, whereupon the actual values are related to a damage value.

RUL model 301 may estimate the damage value by calculating a sum of the minor nominal values (nD1) and major nominal values (nD2) to establish a cumulative measure of the impact during the various types of events (e.g., swing impact or drop impact). RUL model 301 may utilize internally developed relationships to estimate the damage value by calculating a sum of the actual values (D1 and D2) for a comprehensive quantification of the cumulative effects during the events, providing insights into the overall stress and wear experienced by the components of machine 101. Such process of estimating total damage may be performed on each area of interest on machine 101, and may extend to damages associated with events other than the swing impact or the drop impact.

In one instance, the RUL model 301 may implement predictive maintenance strategies, for example, when potential damages are predicted based on observed patterns, the RUL model 301 may trigger alerts or generate recommendations in the user interface 129 of machine 101 or a user device associated with the operator of machine 101. In one example, the recommendations may include customized maintenance schedule (e.g., maintenance schedule 309), customized inspection schedule (inspection recommendation 311), reinforcement kit recommendation 313 (e.g., grouped solutions based on past usage or damage trends), or suggestions to stop the damaging operations. It should be understood that any other actions for mitigating damages to one or more components of machine 101 may be recommended by RUL model 301.

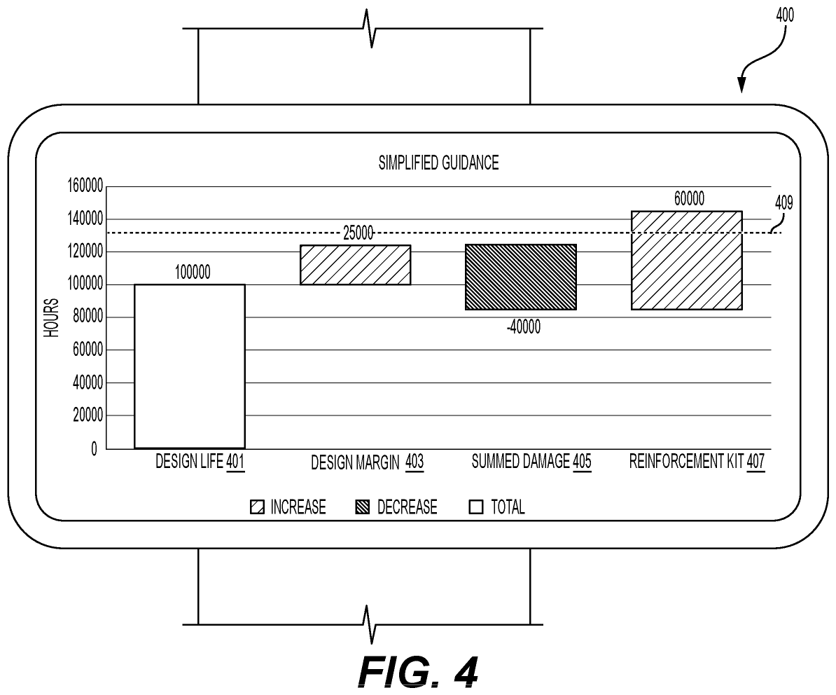

In one instance, RUL model 301 may generate a presentation of simplified guidance 400 in a user interface 129 of machine 101 (as illustrated in FIG. 4) or a user device associated with the operator of machine 101. Simplified guidance 400 may be a set of recommendations tailored to ensure efficient upkeep of machine 101. Simplified guidance 400 may include design life 401 which indicates that one or more components of machine 101 are expected to operate reliably and efficiently for a duration of 100,000 hours under normal operating conditions. Simplified guidance 400 may include design margin 403 indicating an additional time of 25,000 hours beyond the expected lifespan of one or more components of machine 101. This increases the adjusted design life of machine 101 to 125,000 hours. Simplified guidance 400 may also include summed damages 405 that indicate machine 101 has experienced a degradation equivalent to 40,000 hours of its design life due to swing impact or drop impact, reducing the adjusted design life of machine 101 to 85,000 hours. Simplified guidance 400 may also include reinforcement kit 407 that indicates structural modifications or improved components in machine 101 may extend the operational life of machine 101 by 60,000 hours. This increases the adjusted design life of machine 101 to 145,000 hours. The final adjusted design life of machine 101 is above threshold 409, showing the importance of these calculations and assessments for providing a comprehensive understanding of the performance of machine 101, aiding in strategic decision-making, asset optimization, and effective maintenance practice. The above-mentioned hours for design life 401, design margin 403, summed damage 405, and reinforcement kit 407 in FIG. 4 serve as an illustrative example, and the actual hours may vary and can encompass any appropriate number of hours, depending on the factors such as usage, maintenance, and intended application.

In one instance, RUL model 301 may generate a presentation of an inspection map of one or more components (e.g., boom 117) in a user interface 129 of machine 101 or a user device associated with the operator of machine 101. The inspection map may indicate that one or more components of machine 101 have undergone a series of impacts during its operational life, and provides a detailed assessment. In one example, the inspection map may present boom 117 in its entirety, and different sections of boom 117 may be color-coded to highlight specific recommendations. An area of boom 117 may be color-coded (e.g., red color) to signify the need for a die penetrate test to identify any surface cracks or defects that may have resulted from the impacts (e.g., swing or drop impacts). Another area of boom 117 may be color-coded (e.g., blue color) to indicate the need for bore ID measurements, a precise measurement of internal bores is crucial for evaluating the condition of boom 117's internal structure. A further area of boom 117 may be color-coded (e.g., yellow color) for a visual inspection of surface condition for any visible signs of wear. By addressing the impact areas and recommending various tests, the inspection map ensures continued reliability and safety of boom 117 throughout its operational life.

### INDUSTRIAL APPLICABILITY

The disclosed methods and systems for determining the remaining useful life (RUL) of one or more components of a machine may be used in any type of machine associated with an industry such as construction, mining, farming, transportation, or any other industry known in the art. In one instance, determining, in real-time or near real-time, RUL may allow for proactive and timely maintenance, thereby preventing unplanned breakdowns and reducing the likelihood of costly repairs. In one instance, RUL predictions may be utilized to address potential issues before they escalate, such a preventive approach ensures that the equipment continues to perform effectively for a longer period and extends the overall lifespan of the machines. The timely maintenance based on RUL predictions may contribute to improved safety and increased efficiency.

FIG. 5 is a flowchart of a process for predicting conditions of one or more components of machine 101. In one instance, RUL model 301 performs one or more portions of the process 500 and are implemented using, for instance, a chip set including a processor and a memory of controller 109. The processor is configured to perform such processes by having access to instructions (e.g., software or computer-readable code) stored in the memory that, when executed by one or more processors, cause one or more processors to perform the processes. Although the process 500 is illustrated and described as a sequence of steps, it is contemplated that various embodiments of the process 500 are performed in any order or combination and need not include all of the illustrated steps.

In step 501, RUL model 301 may receive impact data from sensors 131 associated with machine 101. Sensors 131 may include a load sensor, an IMU sensor, or any other sensors depending on the nature of the impact being monitored and the environment in which machine 101 operates. Sensors 131 are strategically placed on various parts of machine 101.

In step 503, RUL model 301 may process the impact data to identify a swing impact or a drop impact on one or more components of machine 101. The impact data may include swing impact data 305 a function of forces experienced by arm assembly 107 and/or main body 103 of machine 101 from a collision (e.g., with wall 209) during a swing motion (as illustrated in FIG. 2A). The impact data may include drop impact data 307 a function of forces experienced by main body 103 and/or undercarriage 105 of machine 101 from a landing of a portion of machine 101 on the ground while performing a task (as illustrated in FIG. 2B).

In step 505, RUL model 301 may assign damage values to one or more components of machine 101 based on the impact data. RUL model 301 may use the impact data to determine a type of damage event (e.g., swing impact or drop impact), and may assign damage values to one or more components of machine 101 based on the type of damage event. Such assigned damage values based on the type of damage event are predetermined damage values. In one instance, RUL model 301 may correlate the impact data to the damage values based on an established relationship for assigning the damage values to one or more components of machine 101. In one instance, processing the impact data to assign the damage value includes load data (e.g., load data 303) corresponding to an amount of material in implement 125 of machine 101 during the impact. The RUL model may calculate a sum of the damage values to represent the total damage of machine 101, and may display a representation of the total damage of machine 101 as a function of life hours on user interface 129 of machine 101 (e.g., FIG. 4).

In step 507, RUL model 301 may generate a presentation of recommendation(s) or machine life estimation(s) based on the damage value in a user interface 129 of machine 101 or a device associated with an operator for performing mitigation action(s) to prevent the occurrence of at least one predicted damage. The recommendations may include maintenance of machine 101, inspection of machine 101, reinforcement kits, or pausing the damaging operation of machine 101. The machine life estimations may include factors such as usage intensity, maintenance history wear and tear analysis, and structural integrity assessment. In such manner, by simulating and analyzing historical and real-time data associated with swing impact and drop impact, the RUL model 301 may predict when components may reach the end of their useful life. This predictive capability allows for planned maintenance interventions before critical failure occurs, reducing unexpected downtime and costly repairs. Additionally, it enables optimization of usage of one or more components of machine 101 by scheduling maintenance activities during planned downtimes, minimizing disruption to operations and maximizing overall equipment reliability and longevity.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A computer-implemented method for predicting conditions of one or more components of a machine comprising:
receiving impact data from one or more sensors associated with the machine;
processing the impact data to assign damage values to the one or more components of the machine; and
generating one or more recommendations or machine life estimations based on the damage values in a user interface of the machine.

2. The computer-implemented method of claim 1, wherein the impact data includes swing impact data, and wherein the swing impact data is a function of forces experienced by at least one of an arm assembly or a main body of the machine from a collision during a swing motion.

3. The computer-implemented method of claim 1, wherein the impact data includes drop impact data, and wherein the drop impact data is a function of forces experienced by at least one of a main body or an undercarriage of the machine from a landing of a portion of the machine on ground while performing a task.

4. The computer-implemented method of claim 1, wherein assigning the damage values to the one or more components of the machine includes using the impact data to determine a type of damage event, and assigning the damage values based on the type of damage event.

5. The computer-implemented method of claim 4, wherein the assigned damage values based on the type of damage event are predetermined damage values.

6. The computer-implemented method of claim 5, wherein assigning the damage values to the one or more components of the machine includes correlating the impact data to the damage values based on an established relationship.

7. The computer-implemented method of claim 6, wherein processing the impact data to assign the damage values further includes load data corresponding to an amount of material in an implement of the machine during impact.

8. The computer-implemented method of claim 1, further comprising:
calculating a sum of the damage values to represent a total damage of the machine, and displaying a representation of the total damage of the machine as a function of life hours on the user interface.

9. The computer-implemented method of claim 1, wherein the one or more sensors include a load sensor or an inertial measurement unit (IMU) sensor.

10. The computer-implemented method of claim 1, wherein the one or more recommendations include maintenance of the machine, inspection of the machine, or pausing an operation of the machine.

11. The computer-implemented method of claim 1, wherein the machine is an excavator, and the impact data includes swing impact data and drop impact data of the excavator.

12. A system for predicting remaining useful life of one or more components of a machine comprising:
one or more processors; and
at least one non-transitory computer readable medium storing instructions which, when executed by the one or more processors, cause the one or more processors to perform operations comprising:
receiving sensor data from one or more sensors associated with the machine;
processing the sensor data to determine an impact on the one or more components of the machine;
assigning damage values to the one or more components of the machine based on the determined impact; and
generating one or more notifications for performing one or more mitigation actions based on the damage values in a user interface of the machine.

13. The system of claim 12, wherein the sensor data include impact data, and wherein the impact data includes swing impact data or drop impact data.

14. The system of claim 13, wherein the swing impact data is a function of forces experienced by at least one of an arm assembly or a main body of the machine from a collision during a swing motion, and wherein the drop impact data is the function of forces experienced by at least one of the main body or an undercarriage of the machine from a landing of a portion of the machine on ground while performing a task.

15. The system of claim 12, wherein assigning the damage values to the one or more components of the machine includes using the impact data to determine a type of damage event, and assigning the damage values based on the type of damage event.

16. The system of claim 15, wherein assigning the damage values to the one or more components of the machine includes correlating the sensor data to the damage values based on an established relationship.

17. The system of claim 16, further comprising:
calculating a sum of the damage values to represent a total damage of the machine, and displaying a representation of the total damage of the machine as a function of life hours on the user interface.

18. A non-transitory computer readable medium for predicting conditions of one or more components of a machine, the non-transitory computer readable medium storing instructions which, when executed by one or more processors, cause the one or more processors to perform operations comprising:
receiving swing impact data or drop impact data from one or more sensors associated with the machine;
processing the swing impact data or the drop impact data to assign a damage values to the one or more components of the machine; and
generating one or more notifications or machine life estimations based on the damage values in a user interface of the machine.

19. The non-transitory computer readable medium of claim 18, wherein assigning the damage values to the one or more components of the machine includes using the swing impact data or the drop impact data to determine a type of damage event, and assigning the damage values based on the type of damage event.

20. The non-transitory computer readable medium of claim 19, wherein assigning the damage values to the one or more components of the machine includes correlating the swing impact data or the drop impact data to the damage values based on an established relationship.
